(19) United States
(12) Patent Application Publication
(10) Pub. No.: US 2024/0241007 A1
(43) Pub. Date: Jul. 18, 2024

(54) DEVICE FOR COOLANT LEAK DETECTION ON PRINTED CIRCUIT BOARDS

(71) Applicant: NVIDIA CORPORATION, Santa Clara, CA (US)

(72) Inventors: Anthony David Gamerman, Apex, NC (US); Israel Silva Dias, Apex, NC (US); Kyle Patrick Roberts, Raleigh, NC (US); Steven Hart Penna, Wake Forest, NC (US)

(73) Assignee: NVIDIA CORPORATION, Santa Clara, CA (US)

(21) Appl. No.: 18/097,052

(22) Filed: Jan. 13, 2023

(51) Int. Cl. G01M 3/16; H01B 5/14

(52) U.S. Cl. CPC G01M 3/16; H01B 5/14

(57) ABSTRACT

Devices, systems, and methods are provided for surface-mounted leak detection on a printed circuit board. An example leak detection device includes a first and second electrical contact with a selectively conductive material disposed therebetween. At a first electrical conductivity of the selectively conductive material, the device has a first circuit state. The selectively conductive material is configured to change from the first electrical conductivity to a second electrical conductivity in an instance in which a predetermined amount of fluid is absorbed by the selectively conductive material. At the second electrical conductivity of the selectively conductive material, the device has a second circuit state indicative of a fluid leak. Corresponding systems and methods are also provided.

### TECHNOLOGICAL FIELD

Example embodiments of the present disclosure relate generally to leak detection for electrical components, such as printed circuit boards.

### BACKGROUND

As circuitry in data centers evolves in size and complexity, methods of cooling system components have similarly evolved to match the growing needs. In methods involving liquid coolant, coolant leaks may be a source of system damage and/or may otherwise impair the proper operation and maintenance of electrical components and related systems. Applicant has identified numerous deficiencies and problems associated with conventional coolant leak detection. Through applied effort, ingenuity, and innovation, many of these identified problems have been solved by developing solutions that are included in embodiments of the present disclosure, many examples of which are described in detail herein.

### BRIEF SUMMARY

Embodiments of the present disclosure are directed to a leak detection device, such as a surface mount leak detection device, and associated methods of leak detection. In some embodiments, the leak detection device may include a first electrical contact, a second electrical contact, and a selectively conductive material disposed between and in electrical communication with the first electrical contact and the second electrical contact. At a first electrical conductivity of the selectively conductive material, the device may have a first circuit state. The selectively conductive material may further be configured to change to a second electrical conductivity when a predetermined amount of fluid is absorbed by the selectively conductive material. At the second electrical conductivity of the selectively conductive material, the device may have a second circuit state indicative of a fluid leak.

In some embodiments, the first electrical conductivity of the selectively conductive material may be non-conductive, and the first circuit state may be an open circuit. The second electrical conductivity of the selectively conductive material may be conductive, and the second circuit state may be a closed circuit.

In some embodiments, the selectively conductive material may comprise salt.

In some embodiments, the leak detection device may further comprise an insulative casing at least partially surrounding the first and second electrical contacts. The leak detection device may further comprise first component contact in electrical communication with the first electrical contact and a second component contact in electrical communication with the second electrical contact. The first and second component contacts may be configured to engage corresponding contacts on a printed circuit board.

In some embodiments, the insulative casing may comprise a ceramic material.

In some embodiments, the first electrical conductivity of the selectively conductive material may be conductive, and the first circuit state may be a closed circuit. The second electrical conductivity of the selectively conductive material may be non-conductive and the second circuit state may be an open circuit.

In some embodiments, the selectively conductive material may comprise potassium.

In some embodiments, the leak detection device may comprise an absorbent insulation at least partially surrounding the selectively conductive material, wherein the absorbent insulation may be configured to absorb fluid. Upon absorption of a predetermined amount of fluid, the absorbent insulation may be configured to pass the fluid to the selectively conductive material.

In some embodiments, the leak detection device may comprise a protective film covering the selectively conductive material, wherein the protective film is configured to be removed upon installation of the device.

In some embodiments, the device is configured to be electrically connected to a printed circuit board.

A system for detecting fluid leaks is also provided according to some embodiments. The system may comprise a device having a first circuit state, wherein the device is configured to change from the first circuit state to a second circuit state. The device may be disposed on a printed circuit board. The system may further include a detection component disposed on the printed circuit board. The device may be in electrical communication with the detection component, and the detection component may be configured to detect the change from the first circuit state of the device to the second circuit state of the device. The change from first circuit state to the second circuit state may be indicative of a fluid leak.

In some embodiments, the device may comprise a first electrical contact, a second electrical contact, and a selectively conductive material disposed between and in electrical communication with the first electrical contact and the second electrical contact. At a first electrical conductivity of the selectively conductive material, the device may have a first circuit state. The selectively conductive material may be configured to change from the first electrical conductivity to a second electrical conductivity in an instance in which a predetermined amount of fluid is absorbed by the selectively conductive material. At the second electrical conductivity of the selectively conductive material, the device may have a second circuit state.

In some embodiments, the selectively conductive material may comprise salt. The first electrical conductivity may be non-conductive, and the first circuit state may be an open circuit. The second electrical conductivity may be conductive, and the second circuit state may be a closed circuit.

In some embodiments, the selectively conductive material may comprise potassium. The first electrical conductivity may be conductive, and the first circuit state may be a closed circuit. The second electrical conductivity may be non-conductive, and the second circuit state may be an open circuit.

In some embodiments, the device comprises a plurality of devices. The plurality of devices may be disposed on the printed circuit board proximate liquid-sensitive components of the printed circuit board.

In some embodiments, the plurality of devices may be electrically connected in series to the detection component.

In some embodiments, each of the plurality of devices may be individually electrically connected to the detection component.

A method of manufacturing a leak detection device is also provided according to some embodiments. The method may include providing a first electrical contact, providing a second electrical contact, and disposing a selectively conductive material between and in electrical communication with the first electrical contact and the second electrical contact. At a first electrical conductivity of the selectively conductive material, the device may have a first circuit state. The selectively conductive material may be configured to change from the first electrical conductivity to a second electrical conductivity in an instance in which a predetermined amount of fluid is absorbed by the selectively conductive material. At the second electrical conductivity of the selectively conductive material, the device may have a second circuit state indicative of a fluid leak.

In some embodiments, disposing the selectively conductive material between and in electrical communication with the first electrical contact and the second electrical contact may comprise providing an insulative material and forming a reservoir in the insulative material configured to receive the selectively conductive material. The reservoir may be filled with the selectively conductive material. A first component contact may be connected to the first electrical contact, and a second component contact may be connected to the second electrical contact. The first and second component contacts may be configured to engage corresponding contacts on a printed circuit board.

In some embodiments, the method may include disposing a fluid absorbent insulation at least partially around the selectively conductive material. The fluid absorbent insulation may be configured to control moisture ingress from an environment of the leak detection device into the selectively conductive material.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 is a schematic illustration of a leak detection device mounted on the surface of a printed circuit board in accordance with some embodiments described herein;

FIG. 2A illustrates a cross-sectional view of the leak detection device of FIG. 1 in which the first electrical conductivity of the selectively conductive material is non-conductive in accordance with some embodiments described herein;

FIG. 2B illustrates a perspective view of the leak detection device of FIG. 2A;

FIG. 3A illustrates a cross-sectional view of the leak detection device of FIG. 1 in which the first electrical conductivity of the selectively conductive material is conductive in accordance with some embodiments described herein;

FIG. 3B illustrates a perspective view of the leak detection device of FIG. 3A;

FIG. 4 is a schematic illustration of a plurality of leak detection devices arranged in series and connected to a detection component in accordance with some embodiments described herein;

FIG. 5 is a schematic illustration of a plurality of leak detection devices arranged in parallel with each other and individually connected to a detection component in accordance with some embodiments described herein;

FIG. 6 illustrates a perspective view of the plurality of leak detection devices shown in FIG. 4;

FIG. 6A is a schematic illustration of the detection component in accordance with some embodiments described herein; and

FIGS. 7A-7B are flowcharts illustrating a method of manufacturing a leak detection device according to some embodiments described herein.

### DETAILED DESCRIPTION

Embodiments of the present disclosure now will be described more fully hereinafter with reference to the accompanying drawings in which some but not all embodiments are shown. Indeed, the present disclosure may be embodied in many different forms and should not be construed as limited to the embodiments set forth herein; rather, these embodiments are provided so that this disclosure will satisfy applicable legal requirements. Like numbers refer to like elements throughout. As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As described above, printed circuit boards (PCBs) may refer to a medium used to connect electronic components to one another in a controlled manner. PCBs may be configured in a number of ways and may be single-sided (one copper layer), double-sided (two copper layers), or multi-layer (outer and inner layers of copper, alternating with layers of substrate). Electrical components may be fixed to conductive pads on the outer layer of a PCB. The conductive pads, in turn, may have a shape designed to accept the components' terminals to both electrically connect and mechanically attach the electrical components to the PCB. The electrical connection and mechanical attachment may further be accomplished by soldering (a process in which two items are connected using a melted conductive material to attach the two items together) and/or using vias, which may refer to plated-through holes that allow interconnections between layers of the PCB.

As described above, datacenters and other networking environments (e.g., datacom, telecom, and/or other similar data/communication transmission networks), may leverage numerous electronic components (e.g., central processing units, graphics processing units, etc.) to perform the operations associated with these environments. During operation, the heat generated by these components may impact the overall operation or performance of the computing systems. The thermal burden of these components may be reduced through various cooling techniques, which may include use of a liquid (e.g., air, water, or other coolant fluid) to reduce or regulate the temperature of a system by removing the heat that is generated.

As used herein, terms such as “coolant,” “coolant fluid,” “fluid,” “liquid coolant,” etc. refer to a liquid used to reduce or regulate the temperature of a system and may be used interchangeably. Coolant may refer to a high heat capacity heat transfer medium and may be an aqueous solution. Coolant may further refer to any liquid that interacts with the PCB. Examples of coolant may include distilled water, tap water, water with an antibacterial solution, water that may include dyes, or an aqueous solution.

Several conventional methods for dissipating heat or otherwise reducing the thermal burden of these systems rely upon techniques involving coolant fluid. For example, one conventional method of providing coolant to a PCB involves providing a single channel of coolant fluid proximate the PCB, for example along the chassis supporting the PCB, such that the relatively cooler temperature of the coolant fluid draws heat away from the environment of the PCB and its mounted components. However, these liquid-based technologies can be the source of leaks that can cause potential damage to the electronic components, such as when the leak results in unintended interaction between the cooling fluid and the electronic components. Depending on the size, location, duration, and extent of the coolant leak, among other factors, unintended interactions between the cooling fluid and the electronic components may cause interruption of system operations and/or damage to the electronic components located on the PCB. In some cases, such as when a coolant leak goes undetected for a length of time, serious damage or failure of the PCB may result.

In order to address these issues and others, embodiments of the present invention are directed to a device for leak detection, such as leak detection on a PCB. Although the embodiments described below refer to leak detection on a PCB, one skilled in the art in light of this disclosure would understand that embodiments of the devices, systems, and methods described herein could be applied to any type of electrical components or systems. As described in greater detail below, embodiments of the device may be electronically connected and mechanically secured to a surface of a PCB to detect the leakage of coolant onto the PCB. In particular, the embodiments described hereinafter may improve detection of coolant leaks through a surface mounted device (e.g., a device mounted to the surface of the PCB), and, in some embodiments, the device may be configured to identify the location of a leak to allow for more directed remedial action for addressing the leak. Furthermore, the embodiments described herein may enable the creation of configurable remedial actions to minimize damage to potentially coolant-sensitive components. In doing so, embodiments of the present invention can significantly increase response capabilities to protect sensitive components on a PCB and/or more accurately identify the location of a coolant leak on the PCB.

Embodiments of the devices, systems, and methods described below may be surface mount devices (SMDs). An SMD leak detection device may enable leak detection on a surface of the PCB, providing notification of a leak when the leak contacts potentially sensitive components.

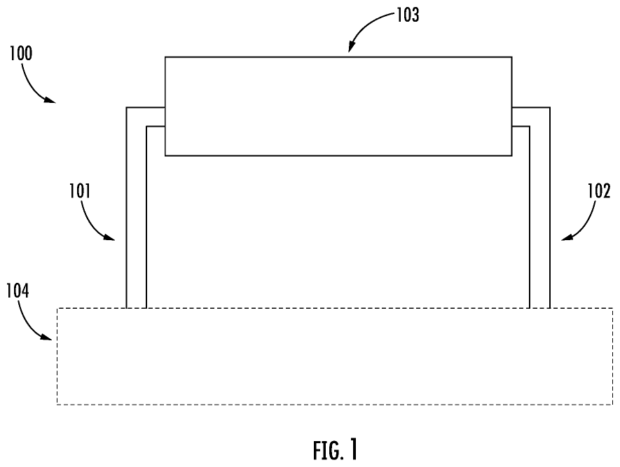

With reference to FIG. 1, a leak detection device 100 according to some embodiments is illustrated. As shown, the leak detection device 100 may include a first electrical contact 101, a second electrical contact 102, and a selectively conductive material 103 disposed between and in electrical communication with the first electrical contact 101 and the second electrical contact 102. In some embodiments, the first electrical contact 101 and the second electrical contact 102 may both be a conductive material that can allow an electrical current to flow through the first electrical contact 101, through the selectively conductive material 103 if the selectively conductive material 103 is conductive, then through the second electrical contact 102 to complete the circuit. As such, the flow of an electrical current through the selectively conductive material 103 to create a closed circuit is dependent on the conductivity of the selectively conductive material 103. As described in greater detail below, the selectively conductive material 103 may be selected such that under certain conditions, the selectively conductive material 103 allows electrical communication through the selectively conductive material 103, the first electrical contact 101, the second electrical contact 102 and the PCB 104, thereby creating a closed circuit. The first electrical contact 101 may be electrically connected and mechanically attached to the PCB 104 in a predetermined location and according to a desired circuit design. The second electrical contact 102 may also be electrically connected and mechanically attached to the PCB 104 in such a way that the leak detection device 100 forms an electrical circuit with the PCB 104. As such, the circuit formed between the leak detection device 100 and the PCB 104 may be open if the selectively conductive material 103 is set conductive or closed if the selectively conductive material 103 is non-conductive.

With continued reference to FIG. 1, a selectively conductive material 103 of an example leak detection device 100 may have a first electrical conductivity and a second electrical conductivity. At the first electrical conductivity of the selectively conductive material, the device 100 may have a first circuit state. The selectively conductive material 103 may be configured to change from the first electrical conductivity to the second electrical conductivity in an instance in which a predetermined amount of fluid is absorbed by the selectively conductive material, and at the second electrical conductivity of the selectively conductive material, the device may in turn have a second circuit state indicative of a fluid leak.

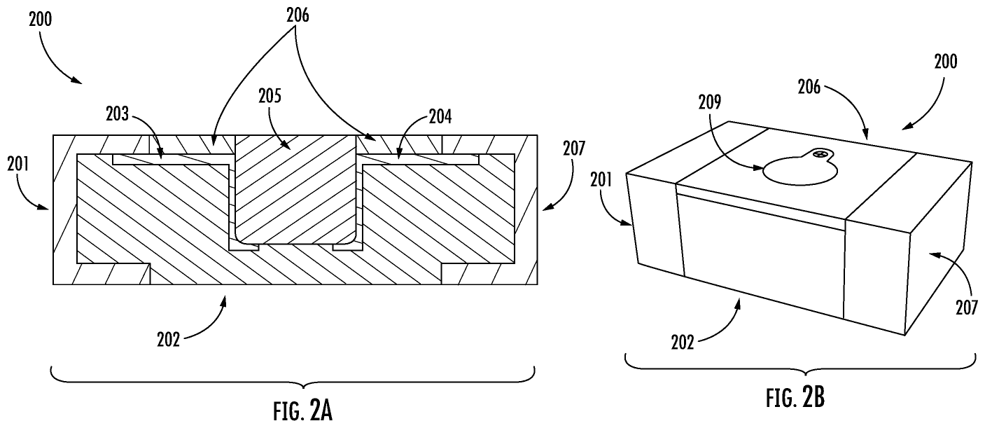

In some embodiments, the first electrical conductivity of the selectively conductive material 103 is non-conductive, and the first circuit state of the leak detection device 100 is open. In such embodiments, the second electrical conductivity of the selectively conductive material 103 is conductive, and the second circuit state of the leak detection device 100 is closed. As a predetermined amount (e.g., volume concentration, etc.) of coolant is encountered (e.g., absorbed) by the selectively conductive material 103, the selectively conductive material 103 may change from non-conductive to conductive. With the selectively conductive material 103 initially non-conductive and becoming conductive, the open circuit of the first circuit state changes to a closed circuit, allowing an electrical current to flow from the PCB 104, through the first electrical contact 101, through the selectively conductive material 103, through the second electrical contact 102, and back to the PCB 104. In such embodiments, the selectively conductive material 103 may be, for example, salt, as described in greater detail below in connection with FIG. 2A and FIG. 2B. The salt, which may be contained in the salt reservoir, has a first electrical conductivity that is non-conductive, such that the first circuit state of the device 100 is an open circuit. When exposed to coolant, the salt changes from the first electrical conductivity (non-conductive) to a second electrical conductivity, which is conductive. The device 100, in turn, changes from the first circuit state (open) to a second circuit state, which is closed.

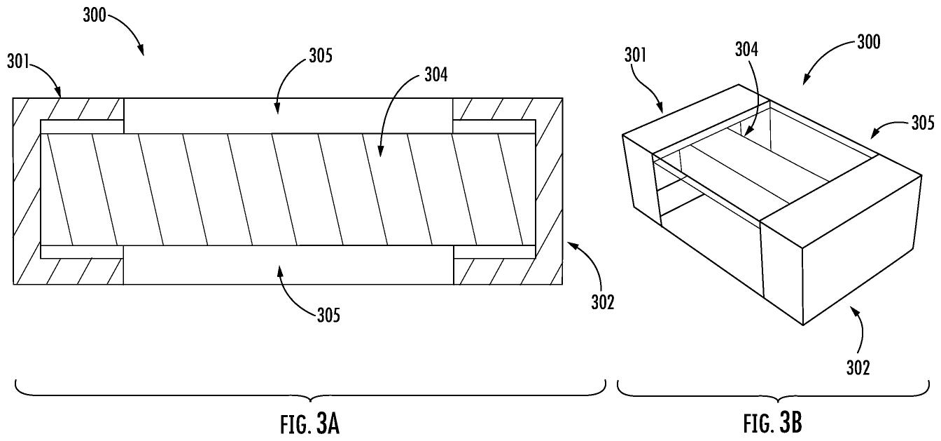

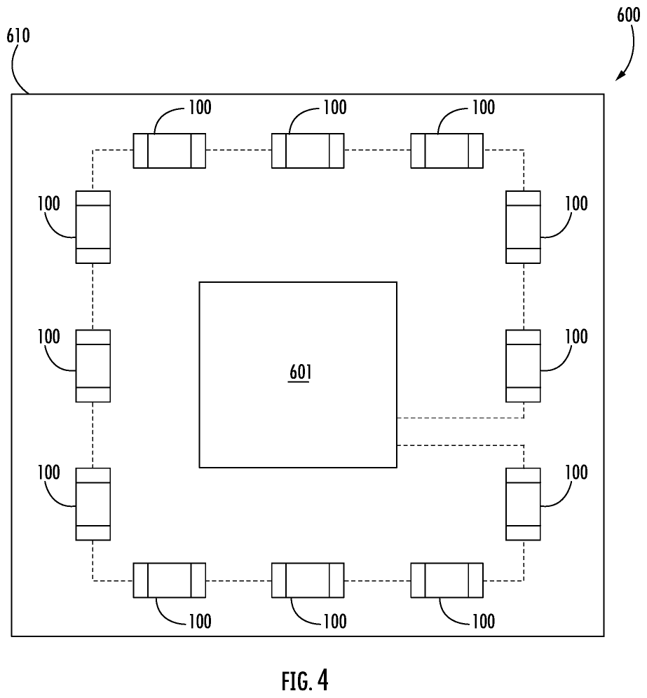

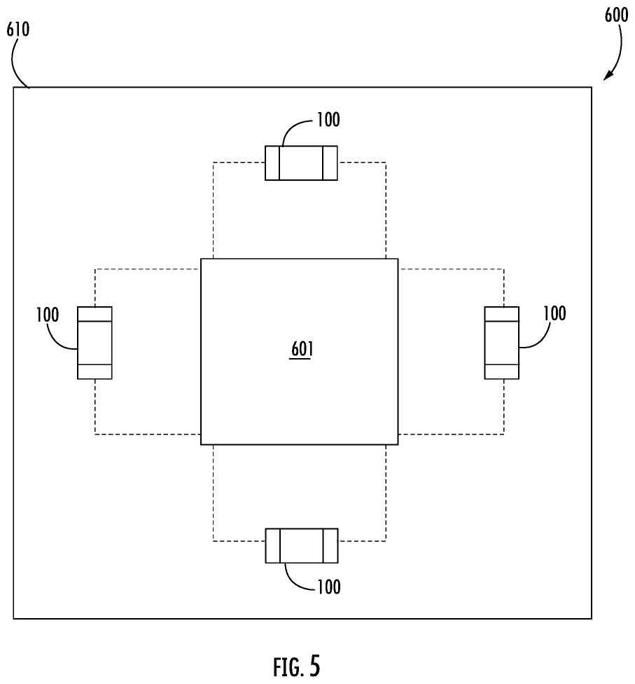

With continued reference to FIG. 1, in some embodiments, the first electrical conductivity of the selectively conductive material 103 is conductive, and the first circuit state of the leak detection device 100 is closed. In such embodiments, the second electrical conductivity of the selectively conductive material 103 is non-conductive, and the second circuit state of the leak detection device 100 is open. As a predetermined amount (e.g., volume concentration, etc.) of coolant is encountered (e.g., absorbed) by the selectively conductive material 103, the selectively conductive material 103 may change from conductive to non-conductive. With the selectively conductive material 103 being non-conductive, the closed circuit of the first circuit state now forms an open circuit, preventing an electrical current from flowing through the leak detection device 100. In such embodiments, the selectively conductive material 103 may be, for example, a potassium core, as described in greater detail below in connection with FIG. 3A and FIG. 3B. The potassium core may have a first electrical conductivity that is conductive, such that the first circuit state of the device 100 is a closed circuit. When exposed to coolant, the potassium core breaks down and changes from the first electrical conductivity (conductive) to a second electrical conductivity, which is non-conductive. The device 100, in turn, changes from the first circuit state (closed) to a second circuit state, which is open.

As described above in reference to FIG. 1, the conductivity of the selectively conductive material 103 can be conductive or non-conductive, based on the type of material selected to serve as the selectively conductive material 103. This initial conductivity can then be changed through the interaction of coolant from conductive to non-conductive or from non-conductive to conductive. In some embodiments, the conductivity of the selectively conductive material 103 may be partially conductive, in that the partial conductivity may be dependent on the amount of coolant interacting with the selectively conductive material 103. In such embodiments, the circuit state of the device may be considered a closed circuit even if the electric current is passing through the device 100 is lower than the electric current of the circuit state when the selectively conductive material is (fully) conductive. For example, in embodiments in which the selectively conductive material 103 is salt in a salt reservoir, as more coolant interacts with the salt, the salt becomes more conductive. In some embodiments, the amount of current running through the salt reservoir may be measured, which in turn may be used to calculate the amount of coolant that has interacted with (e.g., leaked onto) the PCB. The amount of current running through the device 100 may be measured through measurement of the resistance between the first electrical contact 101 and the second electrical contact 102. Measurement of the resistance may be obtained through a multimeter or application of a voltage source on the first electrical contact 101 and measurement of the voltage at the second electrical contact 102, as well as by any other method known by those skilled in the art in light of this disclosure.

As described above, in some embodiments, the conductivity of the selectively conductive material 103 may change in a more binary fashion, alternating between conductivity and non-conductivity when in contact with a predetermined amount of coolant without partial conductivity during the transition. For example, in embodiments in which the selectively conductive material 103 is a potassium core, when a predetermined amount of coolant interacts with the potassium core, the potassium core may break down, changing from being conductive to being non-conductive and thus changing the circuit state of the device from being a closed circuit to an open circuit.

With reference to FIG. 1, the leak detection device 100 may be constructed in multiple standard form factors. The standard form factors may comply with standardized package shapes and sizes used in the electronics industry (e.g., the Joint Electron Device Engineering Council or JEDEC). Embodiments of the leak detection device 100 may be constructed in a package size of 0201 (0.60 mm long, 0.30 mm wide, 0.25 mm high) to a package size of 0805 (2.00 mm long, 1.25 mm wide, and 0.50 mm high), as well as any standard size in between (e.g., 0402 and 0603). Furthermore, in some embodiments, the leak detection device 100 may not be strictly constrained by the standardized form factors described above.

With reference to FIGS. 2A and 2B, an embodiment of the leak detection device 200 in which salt in a salt reservoir 205 is used as the selectively conductive material 103 is illustrated. The first electrical contact 201 performs functions similar to the first electrical contact 101 in FIG. 1. Similarly, the second electrical contact 207 performs functions similar to the second electrical contact 102 in FIG. 1. As described above, in the depicted embodiment in which a salt reservoir is used, the first electrical conductivity of the selectively conductive material 103 may be non-conductive, and the second electrical conductivity of the selectively conductive material 103 may be conductive. Embodiments of the salt reservoir leak detection device 200 may also function as partially conductive, as the electric current flowing through the salt reservoir 205 may increase as increased amounts of coolant interact with the salt reservoir 205, as described above.

With continued reference to FIG. 2A, the leak detection device 200 may comprise an insulative casing 202 at least partially surrounding the first electrical contact 201 and the second electrical contact 207. The insulative casing 202 may comprise an insulative material (e.g., ceramic, rubber, plastic, etc.). The insulative casing 202 may define a cavity of predetermined dimensions in the center of the insulative casing 202 to serve as a reservoir 205 in which the salt used as the selectively conductive material may be stored. Said cavity may be defined in the insulative casing 202 by laser drilling, milling, or other methods. The leak detection device 200 may further comprise a first component contact 203 in electrical communication with the first electrical contact 201 and a second component contact 204 in electrical communication with the second electrical contact 207. The first and second component contacts 203 and 204 may be configured to engage corresponding contacts on the PCB to form the circuit between the PCB and the leak detection device 200. For example, the first component contact 203 may be disposed proximate the top of the insulative casing 202, such that at least a portion of the first component contact engages (touches or otherwise electrically communicates with) the first electrical contact 201. Similarly, the second component contact 204 may be disposed proximate the top of the insulative casing 202, such that at least a portion of the second component contact engages (touches or otherwise electrically communicates with) the second electrical contact 207. Both the first component contact 203 and the second component contact 204 may comprise a conductive metal (e.g., copper, nickel, aluminum, etc.) or other materials capable of creating an electrical connection. In the depicted embodiment, the first component contact 203 and the second component contact 204 are located at opposite sides of the cavity formed in the insulative casing 202. The first component contact 203 and the second component contact 204 may thus be spaced apart from each other, such that they do not contact one another or otherwise create an electrical short. As noted above, the cavity of the insulative casing 202 may be filled with salt to form the salt reservoir 205. The salt reservoir 205 may be constructed in such a way that the salt in the salt reservoir 205 engages (touches or is otherwise able to electrically contact) both the first component contact 203 and the second component contact 204, such as via opposite sides of the salt reservoir as depicted. As such, the salt forming the salt reservoir 205 may at least partially fill the cavity created in the insulative casing 202. The salt reservoir 205 may be constructed to have varying shapes, dimensions, and/or depths for a predetermined conductivity based on the size of the leak detection device 200 and/or the desired functionality of the device. The salt within the salt reservoir 205 can further be configured (e.g., quality of salt, type of salt, amount of salt, etc.) to modify the conductive properties of the salt reservoir 205 (e.g., the amount of coolant needed to change conductivity, the conductive properties of the salt reservoir, etc.). The salt forming the salt reservoir 205 can be further configured to be non-conductive in a solid state and conductive when in an aqueous solution (e.g., when in contact with coolant, a conductive aqueous solution of a predetermined ion concentration may be formed).

In some embodiments, an insulative protective coating 206 may be disposed on top of the first component contact 203 and the second component contact 204 and may at least partially surround the salt reservoir 205. The insulative protective coating 206 may be used to ensure that the electric current flowing through the leak detection device 200 is retained within the device, as well as to provide protection of the components within from outside electrical signals.

Referring to both FIG. 2A and FIG. 2B, embodiments of the leak detection device 200 may further comprise a protective film 209 overlying the salt reservoir 205 that is configured to keep moisture out of the salt reservoir while the protective film 209 is in place. For example, the protective film may, in some cases, be a wash protection sticker that covers the selectively conductive material (e.g., the salt in the salt reservoir 205 in the embodiment depicted in FIG. 2A). In this example, the protective film 209 may thus be configured to prevent fluid from reaching the salt reservoir 205 during the manufacturing process, such as during the process of washing the PCB. The protective film 209 may be configured to be removable after the manufacturing process, such as upon installation of the device onto the PCB or upon installation of the PCB in a larger system. For example, the protective film 209 (e.g., the wash protection sticker) may be removably adhered to a surface of the device surrounding the salt reservoir 205 and may be configured to be peeled off following the manufacturing process (e.g., after the PCB has been washed).

With continued reference to FIG. 2A, the first electrical contact 201, the first component contact 203, the salt reservoir 205, the second component contact 204, and the second electrical contact 207 may be electrically connected to allow electricity to pass when the device 200 is in a closed circuit state. In the depicted embodiment, for example, this may be accomplished when the salt reservoir 205 is conductive, which may occur when the salt in the salt reservoir 205 interacts with a predetermined amount of coolant and changes from being non-conductive to being conductive. This, in turn, may result in the circuit state of the device 200 changing from an open circuit to a closed circuit, such that an electric current can flow from the PCB 104 through the various electrical components, and back to the PCB 104. As noted above, the first electrical contact 201 and the second electrical contact 207 may thus be configured to engage corresponding electrical contacts on the PCB 104.

With reference to FIG. 3A and FIG. 3B, a leak detection device 300 in which potassium in the form of a potassium core 304 is used as the selectively conductive material 103 is illustrated. The first electrical contact 301 performs functions similar to the first electrical contact 101 in FIG. 1. Similarly, the second electrical contact 302 performs functions similar to the second electrical contact 102 in FIG. 1.

As described above, in the depicted embodiment in which a potassium core 304 is used, the first electrical conductivity of the selectively conductive material may be conductive, and the second electrical conductivity of the selectively conductive material may be non-conductive. The absorbent insulation 305 may be configured to absorb coolant or fluid and may be configured to, upon absorption of a predetermined amount of fluid or coolant, pass the absorbed fluid or coolant to the selectively conductive material (e.g., the potassium). The potassium core 304 in the depicted embodiment may be initially conductive, then may change to be non-conductive when encountering coolant.

With continued reference to FIG. 3A and FIG. 3B, the potassium core 304 may engage (e.g., touch or otherwise electrically communicate with) the first electrical contact 301 at one end of the potassium core and may further engage (e.g., touch or otherwise electrically communicate with) the second electrical contact 302 at the opposite end of the potassium core 304. The device 300 may further comprise an absorbent insulation 305 at least partially surrounding the selectively conductive material (e.g., the potassium of the potassium core 304 of FIG. 3A). The absorbent insulation 305 may be configured to absorb fluid. In this way, upon absorption of a predetermined amount of fluid, the absorbent insulation may be configured to pass the fluid to the selectively conductive material (e.g., the potassium of the potassium core 304 in FIG. 3A and FIG. 3B). The absorbent insulation 305 may, for example, include a coolant-absorbing material that directs coolant towards the potassium core 304 once a threshold amount of coolant in the absorbent insulation is reached. The absorbent insulation 305 may also prevent humidity ingress to the potassium core 304, thereby preventing a premature change of conductivity in the potassium core. The absorbent insulation 305 may be selected to absorb a predetermined amount of coolant before reaching the potassium core 304. The absorbent insulation 305 may comprise a variety of materials (e.g., cellulose, mylar type of plastic, thermal detectable plastics, etc.). As such, the absorbent insulation 305 may be configured to control moisture ingress from an environment of the device 300 into the selectively conductive material 103 (e.g., the potassium of the potassium core 304).

With continued reference to FIG. 3A and FIG. 3B, the device 300 may further comprise a protective film covering the selectively conductive material (the potassium of the potassium core 304). In some cases, the protective film may also cover the absorbent insulation 305. The protective film may be configured to be removed upon installation of the leak detection device 300 (e.g., after installation of the device onto a PCB). The protective film may, for example, be placed on surfaces of the leak detection device 300 that may be altered unintentionally during the manufacturing process. Such a premature alteration may be due to exposure to elements that occur before, during, or after the manufacturing process. Accordingly, the protective film may be located on the device so as to cover fully or at least partially one surface of the leak detection device 300.

With continued reference to FIG. 3A and FIG. 3B, the configurations (e.g., size, shape, material, and/or material properties, etc.) of the potassium core 304 and/or the absorbent insulation 305 may be selected according to the amount of coolant needed to alter the conductivity of the potassium core 305 of the leak detection device 300. For example, the configuration of the absorbent insulation 305 may be selected such that a desired amount of coolant may be absorbed by the absorbent insulation 305 before the coolant is allowed to pass through and interact with the potassium core 304, thereby changing the conductivity of the potassium core 304. For instance, the material, absorbent capacity, density, or other properties of the absorbent insulation 305 may be selected so as to cause the absorbent insulation 305 to absorb a desired amount of coolant before allowing the coolant to interact with the potassium core 304.

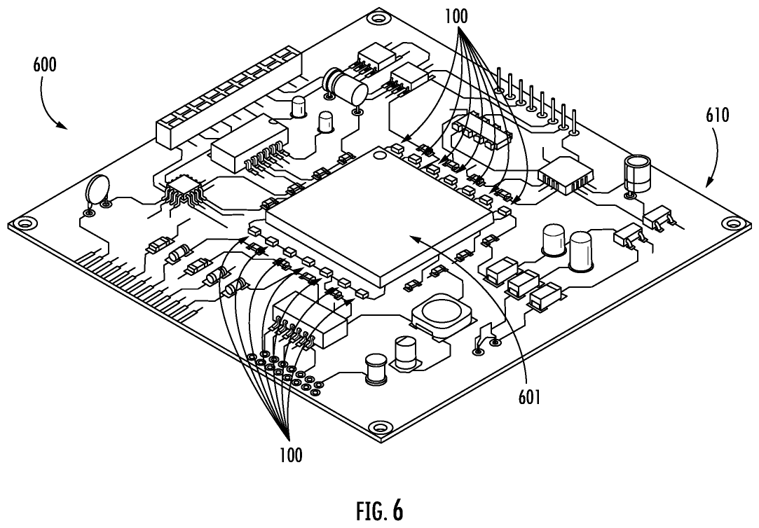

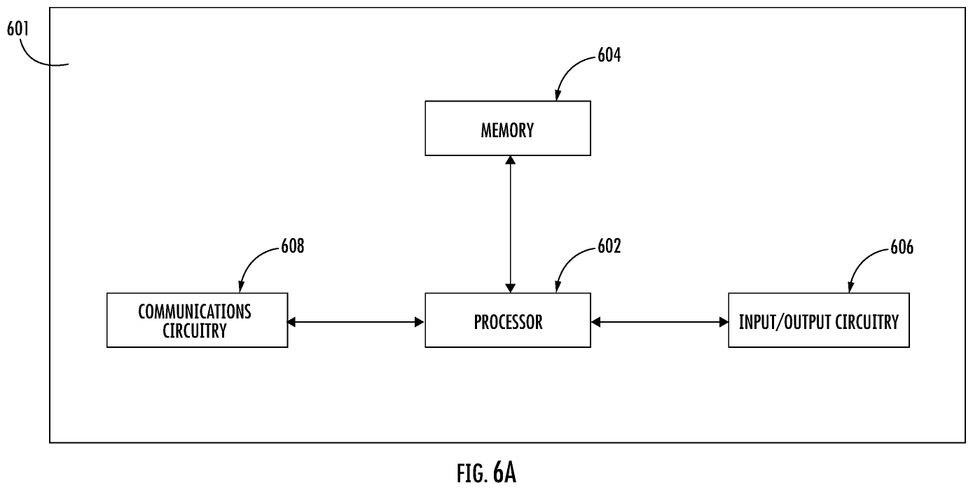

Referring now to FIG. 6, a system for detecting coolant leaks, such as coolant leaks on a surface of a PCB, is illustrated in which embodiments of the leak detection device 100 (which may be a device 200 having a salt reservoir or a device 300 using a potassium core, as shown in FIGS. 2A-2B and 3A-3B, respectively, and described above) provide an indication of a change in the selectively conductive material 103 (e.g., the salt of the salt reservoir or the potassium of the potassium core) to signal that a leak has been detected. Accordingly, embodiments of the system 600 include a device 100 having a first circuit state, where the device is configured to change from the first circuit state to a second circuit state as described above and in connection with FIGS. 1, 2A-2B, and 3A-3B. The device may be disposed on a printed circuit board (PCB) 610, as shown in FIG. 6. The system 600 may further include a detection component 601 disposed on the PCB 610. For example, the detection component 601 may be electrically connected and mechanically attached to the PCB 610. Moreover, the device 100 may be in electrical communication with the detection component 601.

In some embodiments, the detection component 601 may be configured to detect the change from the first circuit state of the device 100 to the second circuit state of the device. Because the change in circuit state is the result of a change in conductivity of the selectively conductive material, as described above, the change from the first circuit state to the second circuit state is indicative of a fluid leak (e.g., a leakage of coolant onto a surface of the PCB). The detection component 601 may be configured to transmit an indication of the fluid leak to a user or downstream component for addressing the leak. The leak detection device 100 may act as a notification to the detection component 601 rather than a switch. In other words, the leak detection device 100 may act as an indicator to the detection component 601 rather than as a fuse directly controlling the PCB 104.

In this regard, and with reference to FIG. 6A, the detection component 601 may comprise circuitry, networked processors, or the like configured to perform some or all of the apparatus-based processes (processes performed by the detection component) described herein and may be any suitable controller, microcontroller, computing device, network server, and/or other type of processing device. In this regard, the detection component 601 may be embodied by any of a variety of devices. For example, the detection component 601 may be configured to receive/transmit data and may include any of a variety of fixed terminals, such as a server, microcontroller, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least the components illustrated in FIG. 6A and described in connection therewith. In some embodiments as shown in FIGS. 4-6, the detection component 601 may be embodied as shown in FIGS. 4-6 such that performance of the operations of FIG. 6A occur on the printed circuit board 104, 610. Despite the many arrangements contemplated herein, the detection component 601 is shown and described herein as a single computing device for ease of explanation and to avoid unnecessarily overcomplicating the disclosure.

As illustrated in FIG. 6A, the detection component 601 may include a processor 602, a memory 604, communications circuitry 608, and input/output circuitry 606. The detection component 601 may be configured to execute the operations described below in connection with FIG. 6A. Although components 602-608 are described in some cases using functional language, it should be understood that the particular implementations necessarily include the use of particular hardware. It should also be understood that certain of these components 602-608 may include similar or common hardware. For example, two sets of circuitry may both leverage use of the same processor 602, memory 604, communications circuitry 608, or the like to perform their associated functions, such that duplicate hardware is not required for each set of circuitry. The use of the term “circuitry” as used herein includes particular hardware configured to perform the functions associated with respective circuitry described herein.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the detection component 601 may provide or supplement the functionality of particular circuitry.

In some embodiments, the processor 602 (and/or co-processor or any other processing circuitry assisting or otherwise associated with the processor) may be in communication with the memory 604 via a bus for passing information among components of the detection component 601. The memory 604 may be non-transitory and may include, for example, one or more volatile and/or non-volatile memories. For example, the memory may be an electronic storage device (e.g., a non-transitory computer readable storage medium). The memory 604 may be configured to store information, data, content, applications, instructions, or the like, for enabling the detection component 601 to carry out various functions in accordance with example embodiments of the present disclosure.

The processor 602 may be embodied in a number of different ways and may, for example, include one or more processing devices configured to perform independently. Additionally, or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the detection component, and/or remote or “cloud” processors.

In an example embodiment, the processor 602 may be configured to execute instructions stored in the memory 604 or otherwise accessible to the processor 602. Alternatively, or additionally, the processor 602 may be configured to execute hard-coded functionality. As such, whether configured by hardware or by a combination of hardware with software, the processor 602 may represent an entity (e.g., physically embodied in circuitry) capable of performing operations according to an embodiment of the present disclosure while configured accordingly. Alternatively, as another example, when the processor 602 is embodied as an executor of software instructions, the instructions may specifically configure the processor 602 to perform the algorithms and/or operations described herein when the instructions are executed.

The detection component 601 may further include input/output circuitry 606 that may, in turn, be in communication with the processor 602 to provide output to a user and to receive input from a user, user device, or another source. The input may, for example, be a signal from one or more leak detection devices, while the output may, for example, be a notification of a leak and/or other leak-related information that is sent to a user. In this regard, the input/output circuitry 606 may comprise a display that may be manipulated by an application. In some embodiments, the input/output circuitry 606 may also include additional functionality such as a keyboard, a mouse, a joystick, a touch screen, touch areas, soft keys, a microphone, a speaker, or other input/output mechanisms. The detection component 601 comprising the processor 602 may be configured to control one or more functions of a display through computer program instructions (e.g., software and/or firmware) stored on a memory accessible to the processor (e.g., the memory 604 and/or the like).

The communications circuitry 608 may be any means such as a device or circuitry embodied in either hardware or a combination of hardware and software that is configured to receive and/or transmit data from/to a network and/or any other device, circuitry, or module in communication with the detection component 601. In this regard, the communications circuitry 608 may include, for example, a network interface for enabling communications with a wired or wireless communication network. For example, the communications circuitry 608 may include one or more network interface cards, antennae, buses, switches, routers, modems, and supporting hardware and/or software, or any other device suitable for enabling communications via a network. Additionally, or alternatively, the communication interface may include the circuitry for interacting with the antenna(s) to cause transmission of signals via the antenna(s) or to handle receipt of signals received via the antenna(s). These signals may be transmitted by the detection component 601 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Exemplary non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM), and the like.

In further reference to FIG. 6, the transmission of an indication of the fluid leak to a downstream component may be accomplished via the detection component 601, such as through electric signals received, processed, and/or transmitted by the detection component as described above in connection with FIG. 6A. In some cases, for example, the detection component 601 may receive a signal from the leak detection device 100 (e.g., device 200 or 300) indicating that the leak detection device 100 has changed circuit state (e.g., due to exposure to a fluid leak, as described above). The detection component 601 may, in turn, transmit a signal to a user indicating that a leak has occurred. Such a signal may trigger remedial actions to address the leak, such as shutting off an electrical current being supplied to the circuit board. Such remedial actions may be automatic (e.g., triggered solely by receipt of a signal from the detection component 601) or may require user intervention. In some embodiments, the detection component 601 may cause a notification to be sent to an external system (e.g., a user smart phone, pager, computer system, etc.), and the external system may facilitate corrective actions to repair the coolant leak.

As described above with respect to FIG. 1, the leak detection device 100 used in the system 600 for detecting fluid leaks may include the first electrical contact 101, the second electrical contact 102, and the selectively conductive material 103. The selectively conductive material 103 may be disposed between and in electrical communication with the first electrical contact 101 and second electrical contact 102. The leak detection device 100 of the system 600 may have a first circuit state, which may be determined by the first conductivity of the selectively conductive material 103. The selectively conductive material 103 may further be configured to change from the first electrical conductivity to a second electrical conductivity in an instance in which a predetermined amount of fluid or coolant is absorbed by the selectively conductive material 103. At the second electrical conductivity of the selectively conductive material 103, the device 100 may have the second circuit state.

In some embodiments, the leak detection device 100 used in the system 600 for detecting fluid leaks may be embodied as the salt reservoir leak detection device 200, as described above in connection with FIG. 2A. In such embodiments, the salt reservoir leak detection device 200 would initially be non-conductive, and the first circuit state would be an open circuit. Moreover, in such embodiments, the second electrical conductivity (after encountering coolant or fluid) would be conductive, and the second circuit state would be a closed circuit.

In other embodiments, the leak detection device 100 used in the system 600 for detecting fluid leaks may be embodied as the potassium core leak detection device 300, as described above in connection with FIG. 3A-3B. In such embodiments, the potassium core leak detection device 300 would initially be conductive, and the first circuit state would be a closed circuit. Moreover, in such embodiments, the second electrical conductivity (after encountering coolant or fluid) would be non-conductive, and the second circuit state would be an open circuit.

With reference to FIG. 6, the leak detection device 100 (which may be the device 200 or the device 300) may be mechanically attached and electrically connected to the PCB 610 in multiple arrangements, depending on the desired configuration of the PCB 610 and/or user preferences. Moreover, the detection component 601 may be disposed on the PCB 610 and may be in electrical communication with and/or electrically connected to the leak detection device 100 in various ways. As described above, the detection component 601 may receive electric signals from the leak detection device 100 and may determine a response based on predetermined settings. The signals, in some cases, may reflect an amount of electric current flowing through the leak detection device 100. The signal may be determined based on the presence of an electric current (closed circuit due to the conductivity of the selectively conductive material), the absence of electrical current (open circuit due to the non-conductivity of the selectively conductive material) or a weakened electrical current (e.g., when the selectively conductive material is partially conductive, as described above).

As shown in FIG. 6, in some cases, a plurality of devices 100 may be disposed on the printed circuit board and electrically connected to the detection device 601. For example, with reference to FIG. 4, the plurality of leak detection devices 100 may be electrically connected in series to the detection component 601. In embodiments in which the leak detection device includes a selectively conductive material that has a first electrical conductivity that is conductive, for example, the series configuration of FIG. 4 may be used. In this arrangement, if a predetermined amount of coolant were to interact with at least one of the leak detection devices 100, the selectively conductive material 103 in the leak detection devices 100 would change from being electrically conductive to being non-conductive, and the closed circuit of the system 600 would become open. The leak detection component 601 would, in turn, sense the change in the circuit of the system 600 and thereby detect that a coolant leak has occurred on the PCB 610.

In some embodiments, the plurality of devices 100 is disposed on the PCB 610 proximate liquid-sensitive components on the surface of the PCB. Because fluid encountered by any one of the leak detection devices 100 will change the state of the system circuit (e.g., the series circuit created between the various leak detection devices 100 and the detection component 601), this embodiment may be used when coolant detection is desired on the PCB level, and the exact location of the fluid leak (e.g., which of the plurality of leak detection devices 100 detected the fluid) is not required.

Leak detection devices 100 may be arranged in series 400 as shown in FIG. 4 in cases where the device 100 uses potassium as the selectively conductive material (e.g., a potassium core leak detection device 300 shown in FIG. 3A and FIG. 3B). By arranging the potassium core leak detection devices 300 in series, an initially closed series circuit of the system 600 is formed. If a predetermined amount of coolant were to interact with any of the potassium core leak detection devices 300, however, the electrical circuit would break, indicating that coolant or fluid has been detected on the PCB 610 at one of the leak detection devices.

Turning next to FIG. 5, in some cases each of the plurality of leak detection devices 100 is individually electrically connected to the detection component 601. In embodiments in which the leak detection device includes a selectively conductive material that has a first electrical conductivity that is non-conductive, for example, the individually-connected configuration of FIG. 5 may be used. Because the selectively conductive material is initially non-conductive, there is initially no electric current flowing between the leak detection devices 100 and the detection component 601 (e.g., each circuit formed between the detection component 601 and a respective leak detection device 100 is an open circuit). If a predetermined amount of coolant were to interact with one of the leak detection devices 100, the selectively conductive material in the leak detection devices 100 would change from being non-conductive to being conductive. The change of conductivity would in turn change the open circuit (formed between the detection component 601 and the respective leak detection device 100) to a closed circuit. As a result, an electric current would flow through the respective leak detection device 100 and would be detected by the detection component 601 connected thereto, signaling to the detection component 601 that a predetermined amount of coolant has been detected on the PCB 610.

Referring again to FIG. 5, in embodiments in which the leak detection device includes a selectively conductive material that has a first electrical conductivity that is conductive, for example, the individually-connected configuration of FIG. 5 may also be used. Because the selectively conductive material is initially conductive, an electric current may flow between the leak detection devices 100 and the detection component 601 (e.g., each circuit formed between the detection component 601 and a respective leak detection device 100 is a closed circuit). If a predetermined amount of coolant were to interact with one of the leak detection devices 100, the selectively conductive material in the leak detection devices 100 would change from being conductive to being non-conductive. The change of conductivity would in turn change the closed circuit (formed between the detection component 601 and the respective leak detection device 100) to an open circuit. As a result, an electric current would cease flowing through the respective leak detection device 100 and would be detected by the detection component 601 connected thereto, signaling to the detection component 601 that a predetermined amount of coolant has been detected on the PCB 610.

The arrangement of leak detection devices 100 using individual connections as illustrated in FIG. 5 may be used not only to alert the system as to the presence of coolant on the PCB 610, but also to give more precise information as to the location of the coolant leak (e.g., as compared to the series arrangement shown in FIG. 4). For example, if a predetermined amount of coolant were to interact with a leak detection device 100 on the left of the PCB 610, the circuit state would change between one or more leak detection devices 100 in that location and the detection component 601. Because the individual connections between the detection component 601 and other leak detection devices 100 would remain in the initial circuit state, the detection component 601 would be able to determine at least a general location on the PCB 610 where a coolant leak has occurred based on the particular leak detection devices 100 that changed to a closed circuit.

Leak detection devices 100 may be arranged with individual connections between the detection component 601 and the respective leak detection devices as shown in FIG. 5 in cases where the device 100 uses salt as the selectively conductive material (e.g., a salt reservoir leak detection device 200 shown in FIG. 2A and FIG. 2B). By placing the salt reservoir leak detection device 200 with an individual connection to the leak detection component 601, each individual connection formed may initially be an open circuit. If a predetermined amount of coolant were to interact with the salt in the salt reservoir in such embodiments, the individual electrical connection would become a closed circuit, indicating that a coolant leak has been detected on the PCB 610 in a location corresponding to the location of the closed circuit leak detection device.

Leak detection devices 100 may also be arranged with individual connections between the detection component 601 and the respective leak detection devices as shown in FIG. 5 in cases where the device 100 uses potassium as the selectively conductive material (e.g., a potassium core leak detection device 300 shown in FIG. 3A and FIG. 3B). By installing the potassium core leak detection device 300 with an individual connection to the leak detection component 601, each individual connection formed may initially be a closed circuit. If a predetermined amount of coolant were to interact with the potassium core in such embodiments, the individual electrical connection would become an open circuit, indicating that a coolant leak has been detected on the PCB 610 in a location corresponding to the location of the closed-circuit leak detection device.

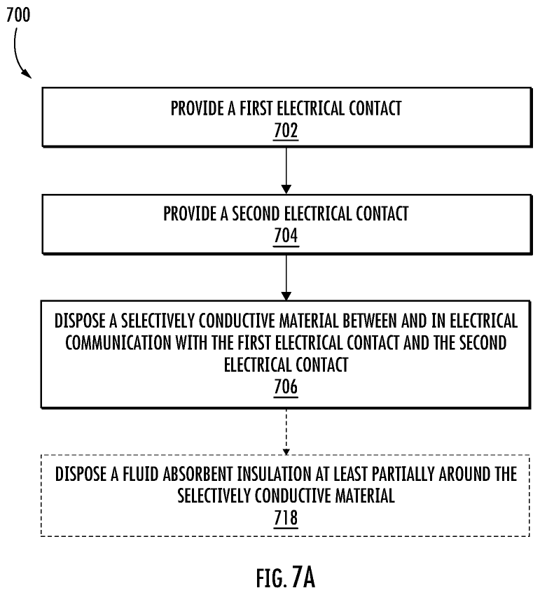

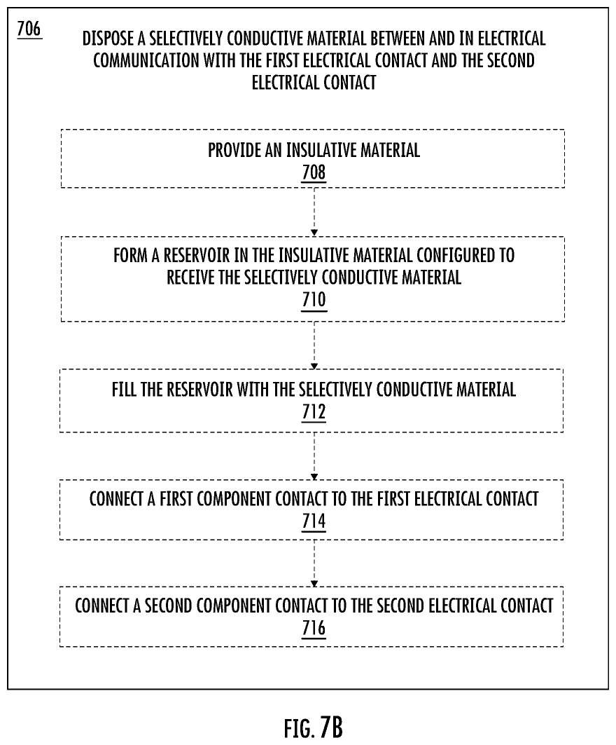

Referring to FIG. 7A, a method of manufacturing the leak detection device 100 is shown that may comprise providing a first electrical contact (Block 702) and providing a second electrical contact (Block 704), as described above. A selectively conductive material may be disposed between and in electrical communication with the first electrical contact and the second electrical contact (Block 706), such as by mechanically attaching and electrically connecting the first and second electrical contacts, respectively, to opposite ends of the selectively conductive material. The electronic connection may allow electrical communication between the first electrical contact and the second electrical contact. The mechanical attachment and electronic connection may be achieved through soldering, welding, brazing, or other mechanisms for securely attaching conductive materials.

At a first electrical conductivity of the selectively conductive material, the device may have a first circuit state. The selectively conductive material may be configured to change from the first electrical conductivity to a second electrical conductivity in an instance in which a predetermined amount of fluid is absorbed by the selectively conductive material. Moreover, as described above, at the second electrical conductivity of the selectively conductive material, the device may have a second circuit state that is indicative of a fluid leak. A protective film may be applied to cover the selectively conductive material, wherein the protective film is configured to be removed upon installation of the device.

Referring to FIG. 7A-7B, in some embodiments, such as when salt is used as the selectively conductive material, the step of disposing the selectively conductive material between and in electrical communication with the first electrical contact and the second electrical contact (Block 706) may comprise providing an insulative material (such as ceramic, rubber, or plastic), such as by providing an insulative casing (Block 708). A reservoir may be formed in the insulative material, and the reservoir may be configured to receive the selectively conductive material (Block 710). As described above, the reservoir may be formed by laser drilling or milling a cavity in the insulative material. In Block 712, the reservoir is filled with the selectively conductive material (e.g., salt). A first component contact may be connected to the first electrical contact (Block 714), such as on one side of the reservoir, and a second component contact may be connected to the second electrical contact (Block 716), such as on the opposite side of the reservoir. The first electrical contact may be attached to the insulative material (e.g., the insulative casing) and the first component contact. The second electrical contact may be attached to the insulative material (e.g., the insulative) and the second component contact. An insulative protective coating may further be applied on the top of the first component contact and the second component contact, as described above. The first component contact and second component contact may be configured to engage corresponding contacts on the PCB.

Referring again to FIG. 7A, in some embodiments, such as when potassium is used as the selectively conductive material, the method of manufacture may further include disposing a fluid absorbent insulation at least partially around the selectively conductive material (Block 718). The potassium core may be mechanically attached and electronically connected to the first electrical contact on one end and a second electrical contact on the opposite end of the potassium core.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of any optical component or optoelectronic element. In addition, the methods described above may include fewer steps in some cases, while in other cases may include additional steps. Modifications to the steps of the method described above, in some cases, may be performed in any order and in any combination.

Therefore, it is to be understood that the disclosure is not to be limited to the specific embodiments disclosed herein and that modifications and other embodiments are intended to be included within the scope of the appended claims. Although specific terms are employed herein, they are used in a generic and descriptive sense only and not for purposes of limitation.

That which is claimed:

1. A device for leak detection comprising:
a first electrical contact;
a second electrical contact; and
a selectively conductive material disposed between and in electrical communication with the first electrical contact and the second electrical contact,
wherein, at a first electrical conductivity of the selectively conductive material, the device has a first circuit state,
wherein the selectively conductive material is configured to change from the first electrical conductivity to a second electrical conductivity in an instance in which a predetermined amount of fluid is absorbed by the selectively conductive material, and
wherein, at the second electrical conductivity of the selectively conductive material, the device has a second circuit state indicative of a fluid leak.

2. The device of claim 1, wherein the first electrical conductivity of the selectively conductive material is non-conductive, and the first circuit state is an open circuit, and wherein the second electrical conductivity of the selectively conductive material is conductive, and the second circuit state is a closed circuit.

3. The device of claim 2, wherein the selectively conductive material comprises salt.

4. The device of claim 2 further comprising:
an insulative casing at least partially surrounding the first and second electrical contacts;
a first component contact in electrical communication with the first electrical contact; and
a second component contact in electrical communication with the second electrical contact,
wherein the first and second component contacts are configured to engage corresponding contacts on a printed circuit board.

5. The device of claim 4, wherein the insulative casing comprises a ceramic material.

6. The device of claim 1, wherein the first electrical conductivity of the selectively conductive material is conductive, and the first circuit state is a closed circuit, and wherein the second electrical conductivity of the selectively conductive material is non-conductive and the second circuit state is an open circuit.

7. The device of claim 6, wherein the selectively conductive material comprises potassium.

8. The device of claim 7 further comprising an absorbent insulation at least partially surrounding the selectively conductive material, wherein the absorbent insulation is configured to absorb fluid, and wherein, upon absorption of a predetermined amount of fluid, the absorbent insulation is configured to pass the fluid to the selectively conductive material.

9. The device of claim 1 further comprising a protective film covering the selectively conductive material, wherein the protective film is configured to be removed upon installation of the device.

10. The device of claim 1, wherein the device is configured to be electrically connected to a printed circuit board.

11. A system for detecting fluid comprising:
a device having a first circuit state, wherein the device is configured to change from the first circuit state to a second circuit state, wherein the device is disposed on a printed circuit board; and
a detection component disposed on the printed circuit board,
wherein the device is in electrical communication with the detection component,
wherein the detection component is configured to detect the change from the first circuit state of the device to the second circuit state of the device, and
wherein the change from the first circuit state to the second circuit state is indicative of a fluid leak.

12. The system of claim 11, wherein the device comprises:
a first electrical contact;
a second electrical contact; and
a selectively conductive material disposed between and in electrical communication with the first electrical contact and the second electrical contact,
wherein, at a first electrical conductivity of the selectively conductive material, the device has the first circuit state,
wherein the selectively conductive material is configured to change from the first electrical conductivity to a second electrical conductivity in an instance in which a predetermined amount of fluid is absorbed by the selectively conductive material, and
wherein, at the second electrical conductivity of the selectively conductive material, the device has the second circuit state.

13. The system of claim 12, wherein the selectively conductive material comprises salt, wherein the first electrical conductivity is non-conductive and the first circuit state is an open circuit, and wherein the second electrical conductivity is conductive and the second circuit state is a closed circuit.

14. The system of claim 12, wherein the selectively conductive material comprises potassium, wherein the first electrical conductivity is conductive and the first circuit state is a closed circuit, and wherein the second electrical conductivity is non-conductive and the second circuit state is an open circuit.

15. The system of claim 11, wherein the device comprises a plurality of devices, wherein the plurality of devices is disposed on the printed circuit board proximate liquid-sensitive components of the printed circuit board.

16. The system of claim 15, wherein the plurality of devices is electrically connected in series to the detection component.

17. The system of claim 15, wherein each of the plurality of devices is individually electrically connected to the detection component.

18. A method of manufacturing a leak detection device, the method comprising:
providing a first electrical contact;
providing a second electrical contact; and
disposing a selectively conductive material between and in electrical communication with the first electrical contact and the second electrical contact,
wherein, at a first electrical conductivity of the selectively conductive material, the device has a first circuit state,
wherein the selectively conductive material is configured to change from the first electrical conductivity to a second electrical conductivity in an instance in which a predetermined amount of fluid is absorbed by the selectively conductive material, and
wherein, at the second electrical conductivity of the selectively conductive material, the device has a second circuit state indicative of a fluid leak.

19. The method of claim 18, wherein disposing the selectively conductive material between and in electrical communication with the first electrical contact and the second electrical contact comprises:
providing an insulative material;
forming a reservoir in the insulative material configured to receive the selectively conductive material;
filling the reservoir with the selectively conductive material;
connecting a first component contact to the first electrical contact; and
connecting a second component contact to the second electrical contact,
wherein the first and second component contacts are configured to engage corresponding contacts on a printed circuit board.

20. The method of claim 18 further comprising:
disposing a fluid absorbent insulation at least partially around the selectively conductive material, wherein the fluid absorbent insulation is configured to control moisture ingress from an environment of the leak detection device into the selectively conductive material.
